(19) United States
(12) Patent Application Publication
(10) Pub. No.: US 2007/0209249 A1
(43) Pub. Date: Sep. 13, 2007

(54) Display rotating apparatus preventing slip by rotary inertia

(75) Inventors: Sang-Min Woo, Suwon-si (KR); Chil-Sung Lee, Suwon-si (KR); Kyoung-Shin Park, Suwon-si (KR); Dong-Won Choi, Suwon-si (KR); Jae-Kyung Kim, Ansan-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/701,529

(22) Filed: Feb. 2, 2007

(30) Foreign Application Priority Data
Feb. 2, 2006 (KR) 10-2006-0009965

(51) Int. Cl. G09F 19/00

(52) U.S. Cl. 40/430

(57) ABSTRACT

A display rotating apparatus capable of preventing a slip phenomenon which occurs by rotary inertia. The display rotating apparatus comprises: a motor providing a driving force for rotating a display; and a motor driving device driving to rotate and stop gradually by increasing a rising time and a falling time of a rotation command signal. the display rotating apparatus can remove the slip phenomenon generated mechanically by increasing or decreasing slowly an applying voltage and/or current applied to the motor and reduce the sway by vibration at the time of stopping the display.

### CROSS-REFERENCE TO RELATED APPLICATIONS

This application claims the benefit of Korean Patent Application No. 2006-0009965 filed with the Korea Industrial Property Office on Feb. 2, 2006, the disclosure of which is incorporated herein by reference in its entirety.

### BACKGROUND

1. Technical Field

The present invention relates to a display rotating apparatus, and in particular, a display rotating apparatus capable of preventing a slip phenomenon which occurs by rotary inertia.

2. Description of the Related Art

Recently, according to increases in size and weight of displays such as a computer monitor, television, etc., a rotation apparatus which can rotate a display toward a user has been used widely. The rotation apparatus is possible to change the direction of the display toward the user automatically by using a motor, etc.

FIG. 1 is a schematic drawing which shows a conventional display rotating apparatus. Referring to FIG. 1, the conventional display rotating apparatus includes a stand 11 fixed on the floor, etc., a motor 13 of which one end is fixed on the stand 11 and of which the other end is connected a display 15 through a shaft 17. The motor 13 is connected with an external control device (not shown), and a user controls the position of the display 15 using a remote controller. And a reduction gear is included within the motor 13 because the display 15 having a big weight is need of rotating slowly.

Such a display rotating apparatus uses an external power supply for driving the motor 13, besides it can be rotated manually because it is necessary that a user rotates the display 15 by hands if power is not supplied to the display rotating apparatus.

Revolution per minute (RPM) means the number of revolutions per minute when the motor 13 is driven with a rated power under a rated voltage and a rated frequency. Several magnetic poles are generated inside the motor 13, and what a couple of poles are generated is defined as two-pole, what two couples of poles are generated is defined as four-pole, and what three couples of poles are generated is defined as six-pole.

If three phase alternating current is applied to three phase coil, the magnetic pole is generated corresponding to the number of the poles. And the magnetic pole is rotated with an alternation of the current. Like this, that the coil is stopping and the magnetic pole only rotates is called as a rotating magnetic field. Since the rotating magnetic field moves next poles per half cycle, a synchronized speed with which the magnetic field rotates is described as Equation 1.
Ns=120f/P (rpm) [Equation 1]

Here, f means frequency (Hz) and P means the number of poles.

A rotor of the motor 13 rotates with almost same speed as Ns under no load, but the rotating speed is decreased by several percent (%) if a load (for example, the, display 15) is carried. This is called as slip.

In case of applying a power or cutting a power after applying through the outer control device for rotating the motor 13 of the display rotating apparatus, the slip phenomenon like above described occurs by rotary inertia of the display 15 mechanically. The slip phenomenon deteriorates stability at the time of moving and stopping product, and sway occurs by vibration at the time of stopping the rotating display.

Also, FIG. 2 shows voltage and current applied to the motor 13. A graph in black is voltage 21, and a graph in gray is current 23. It shows an area A where a current increases rapidly when a voltage is applied to the motor 13, and also an area B where a current increases rapidly when a voltage is cut to the motor 13. Such rapid increases of the current cause malfunction of circuits for driving the motor 13.

### SUMMARY

Therefore, the present invention provides a display rotating apparatus which can prevent the slip phenomenon by rotary inertia.

Also, the present invention provides a display rotating apparatus which can remove the slip phenomenon generated mechanically by increasing or decreasing slowly an applying voltage and/or current to the motor and reduce the sway by vibration at the time of stopping the display.

Additional aspects and advantages of the present general inventive concept will be set forth in part in the description which follows and, in part, will be obvious from the description, or may be learned by practice of the general inventive concept.

In an embodiment of the present invention, a display rotating apparatus comprises: a motor providing a driving force for rotating a display; and a motor driving device driving to rotate and stop gradually by increasing a rising time and a falling time of a rotation command signal.

The rotation command signal is a binary signal divided into rotation and stop.

The motor driving device comprises: a rotation command signal applying unit generating the rotation command signal to rotate the motor corresponding to an input from outside; an RC integral circuit generating an integral signal that is the rotation command signal of which the rising time and the falling time are increased; and an H-bridge converting the integral signal to a motor applying signal to rotate the motor clockwise or counterclockwise.

The RC integral circuit generates the integral signal that is the rotation command signal of which rising time and falling time are changed by adjusting values of a resistor and a capacitor.

Rotation speed of the motor is changed corresponding to magnitude of the motor input signal, and the magnitude of the motor applying current is changed gradually by the integral signal.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic drawing illustrating a conventional display rotating apparatus;

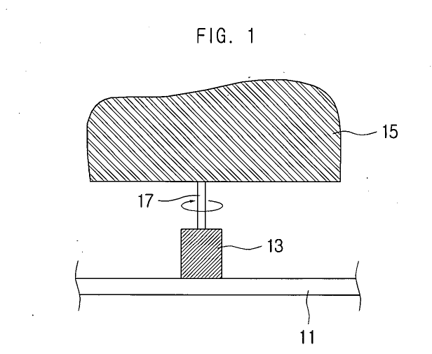

FIG. 2 shows voltage and current applied to a motor.

FIG. 3 is a schematic configuration of a display rotating apparatus according to an embodiment of the present invention.

FIG. 4 shows a motor having general H-bridge structure.

FIG. 5 is a circuit diagram of basic RC integral circuit.

FIG. 6 shows a step response to a step input of the RC integral circuit.

FIG. 7 is integral signal (voltage) generated from RC integral circuit and motor applying current (current) according to an embodiment of the present invention.

### DETAILED DESCRIPTION

The descriptions set forth below merely illustrate the principles of the present invention. Therefore, those skilled in the art could devise various methods and apparatus thereof which realize the principles of the present invention and which do not depart from the spirit and scope of the present invention, even though they may not be clearly explained or illustrated in the present specification. Also, it is to be appreciated that not only the principles, viewpoints, and embodiments of the present invention, but all detailed descriptions listing the particular embodiments are intended to include structural and functional equivalents.

Other objectives, particular advantages, and novel features of the present invention will further be clarified by the detailed descriptions and preferred embodiments set forth below with reference to the accompanying drawings. In the describing the invention, detailed explanation of the prior art will be omitted when it is deemed to unnecessarily obscure the crux of the invention. Numerals used in the descriptions (for example, a first, a second, etc.) are merely used to distinguish equal or similar items in an ordinal manner.

Hereinafter, embodiments of the invention will be described in detail with reference to the accompanying drawings.

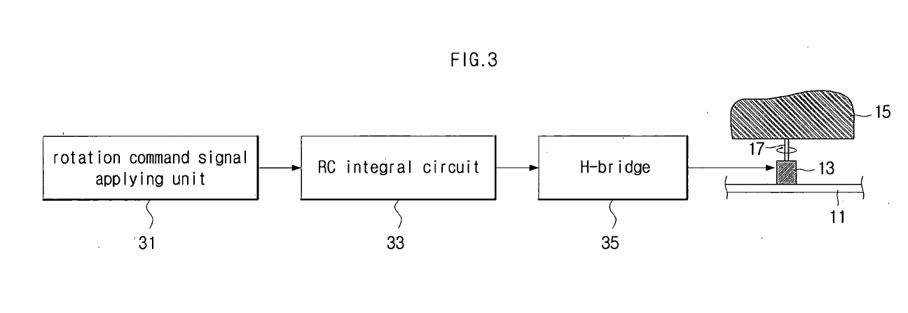

FIG. 3 shows a schematic configuration of a display rotating apparatus according to an embodiment of the present invention.

Referring to FIG. 3, the display rotating apparatus includes a stand 11, a motor 13, a display 15, a shaft 17 and a motor driving device. The display 15 can be applied to various types such as a stand type, a wall mount type, etc., and it is applicable to a television, a monitor, etc.

The display rotating apparatus includes the stand 11 fixed on the floor, etc., the motor 13 of which one end is fixed on the stand 11 and of which the other end is connected the display 15 through the shaft 17. The motor 13 is connected with the motor driving device, and a user controls the position of the display 15 using a remote controller, etc.

And a reduction gear is included within the motor 13 because the display 15 having a big weight is need of rotating slowly. The shaft 17 rotates integrally with the motor 13, and is connected with the display 15. Therefore, the display 15 rotates identically corresponding to the rotation of the shaft 17. The motor 13 provides a driving force for rotating the display 15.

Or one end of the motor 13 is fixed on the display 15, and the other end of the motor 13 is connected with the stand 11 through the shaft 17. At this time, the display 15 and the motor 13 rotate integrally centering around the shaft 17 fixed on the stand 11.

The motor driving device drives the motor 13 to let the display 15 rotate clockwise and/or counterclockwise corresponding to a rotation command signal. The rotation command signal is applied through the remote controller, etc. by the user. It includes information of a rotation direction such as clockwise and/or counterclockwise, and may include information of a rotation speed.

The motor driving device provides a motor applying current to rotate the motor 13 while the rotation command signal is applied, and does not provide the motor applying current, while the rotation command signal is not applied, to stop the motor 13.

The motor driving device includes a rotation command signal applying unit 31, an RC integral circuit 33, and an H-bridge 35.

The rotation command signal related to the rotation of the display 15 is applied to the rotation command signal applying unit 31 from outside or through an input unit (not shown) by the user. And the rotation command signal applying unit 31 transmits the rotation command signal to the RC integral circuit 33 for driving the motor 13. The rotation command signal is a binary signal divided into rotation and stop.

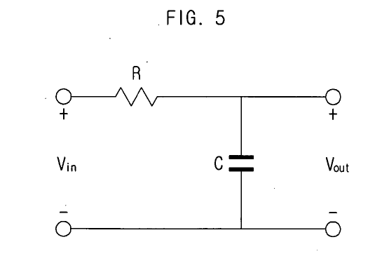

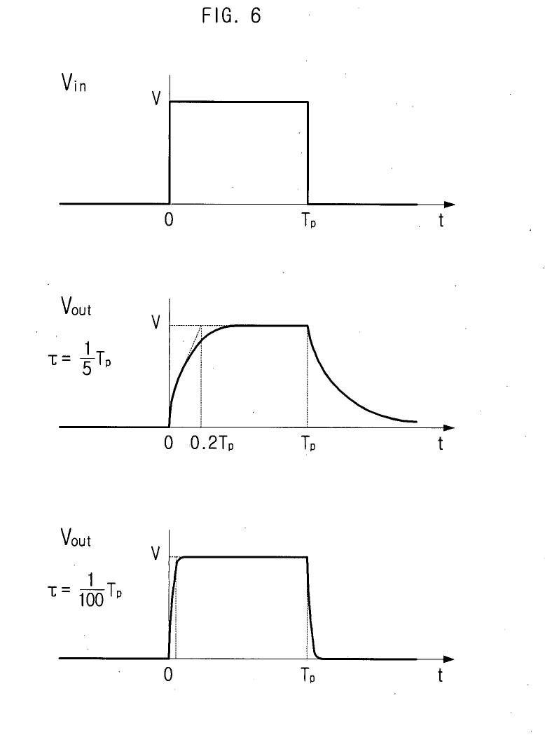

The RC integral circuit 33 is a low pass filter (LPF) composed with a resistor and a capacitor. The RC integral circuit 33 generates an integral signal by increasing a rising time and a falling time of the rotation command signal so that the rotation command signal transmitted from the rotation command signal applying unit 31 does not rapidly change its magnitude. The working theory will be described referring to FIGS. 5 and 6 later on.

The H-bridge 35 converts the integral signal, that is the rotation command signal of which the rising time and the falling time increased in the RC integral circuit 33, to a motor applying current rotating the motor 13 clockwise or counterclockwise, and provides the result to the motor 13.

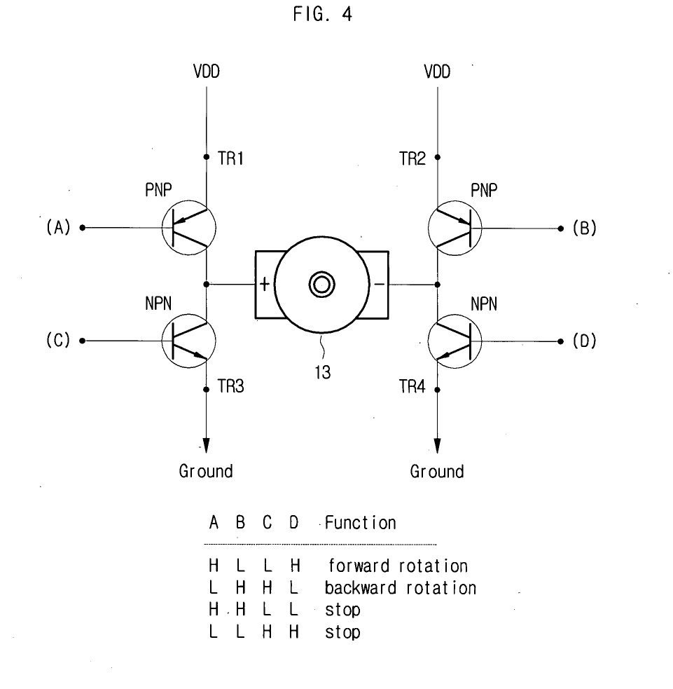

FIG. 4 shows a motor having general H-bridge structure. Referring to FIG. 4, each transistor (TR1, TR2, TR3, TR4) connected with the motor 13 plays a role of switch.

In a table shown in the lower part of FIG. 4, if H signal is applied to A and D and L signal is applied to the others, TR1 and TR4 are respectively connected electrically to rotate the motor 13 forward. If H signal is applied to B and C and L signal is applied to the others, TR2 and TR3 are respectively connected electrically to rotate the motor 13 backward. If H signal is applied to A and B or to C and D, the motor 13 is stopped. Here, each transistor may be a field effect transistor (FET).

The rotation direction of the motor 13 is determined by the above method, and the rotation speed of the motor 13 is determined corresponding to the magnitude of the H signal and/or L signal.

By using the rotation command signal, H signal and/or L signal are applied to A, B, C, D terminal so as to work corresponding to the table. Since the rising time and the falling time of the rotation command signal are increased, H signal and/or L signal applied to A, B, C, D terminal don't change its magnitude rapidly, but gradually. H signal and/or L signal control the motor applying current through each transistor (TR1, TR2, TR3, TR4) to rotate the motor 13 gradually.

Hereinafter the theory of increasing the rising time and the falling time of the rotation command signal is described referring to FIGS. 5 and 6.

FIG. 5 is a circuit diagram of basic RC integral circuit and FIG. 6 shows a step response to a step input of the RC integral circuit. The rotation command signal determines rotation or stop, so that the rotation command signal is a binary signal that is high signal in a case of rotation and low signal in a case of stop. Therefore, the rotation command signal has a rectangular waveform as shown in FIG. 6.

Since the rotation command signal has generally the form of voltage, the rotation command signal of the rotation command signal applying unit 31 is defined to Vin, and the integral signal increasing the rising time and the falling time of the rotation command signal by the RC integral circuit 33 is defined to Vout.

Referring to FIG. 5, in the RC circuit composed with a resistor and a capacitor, the resistor and the capacitor are connected serially and the rotation command signal, Vin, is applied to both ends of the resistor and the capacitor. And the voltage of both ends of the capacitor is defined to Vout. The relationship between Vin and Vout is described in Equation 2 from a standpoint of frequency and time. Here, Vin is a step input having the value of V.

$$\frac{{V}_{out}}{{V}_{i n}} = \frac{1}{1 + SRC} \qquad [ Equation 2 ]$$

Vₒᵤₜ=V−Ve^{-1/τ}(wherein, τ=RC)

Referring to FIG. 6, the step response waveform of Vout is shown corresponding to Equation 2. If the time when the value of Vin maintains V is Tp, the step response waveform in case of τ=Tp/5 and τ=Tp/100 is shown. Here, τ is time constant and meets τ=RC in the circuit as shown in FIG. 5. Time constant means time when output waveform becomes e⁻¹ times (about 63.2%) of input waveform.

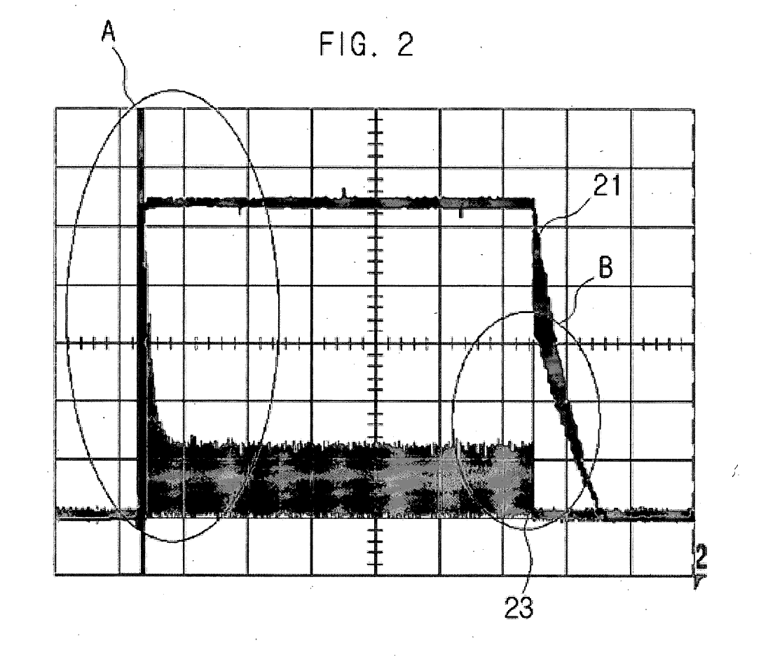

In the case of time constant τ is very smaller compared with Tp, the output waveform similar to the input waveform is generated because the rising time and the falling time of the output waveform is very short as like the case of τ=Tp/100 shown in FIG. 6. In this case, the overshoot is apt to occur as if shown in FIG. 2. Otherwise, referring to the case of τ=Tp/5 as shown in FIG. 6, the output waveform of which the rise edge and the falling edge is similar to that of a trapezoid waveform, not that of a rectangular waveform is generated because of increase of the rising time and the falling time of the output waveform.

Therefore, by controlling the values of the resistor and the capacitor, the rotation command signal having the rectangular waveform is converted to the signal of the trapezoid waveform having various rising times and falling times. Because of this, the position of the display 15 is changed and rotated gradually when the motor starts or stops rotation.

Here the RC integral circuit composed with the resistor and the capacitor as shown in FIG. 5 is one embodiment, therefore it will be appreciated by those skilled in the art that change of the RC integral circuit to another circuit having same function by same theory, without departing from the scope of the present invention.

This is possible that the circuit of the motor driving device does not overwork, and prevents the slip phenomenon by rotary inertia of the display 15 and prevents rotation or vibration of the display 15 when the motor 13 stops its rotation.

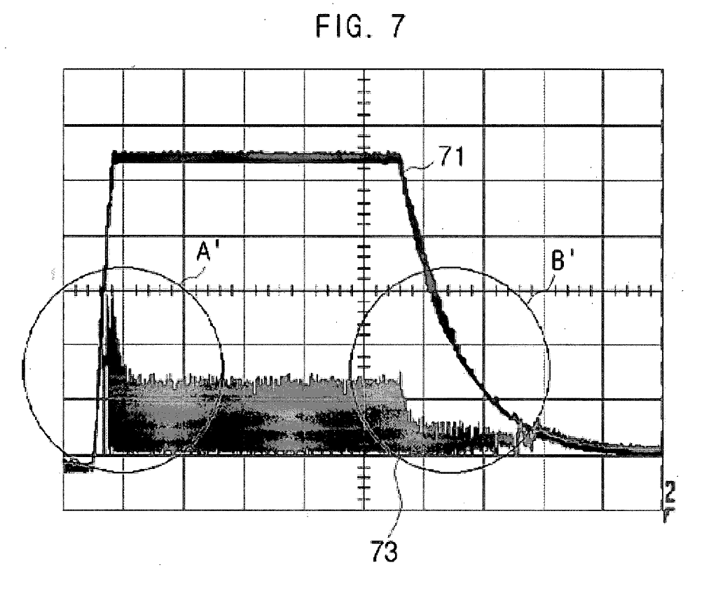

FIG. 7 shows the integral signal (voltage) and the motor applying current (current) generated in the RC integral circuit 33 according to an embodiment of the present invention. A graph in black represents the integral signal 71 and a graph in gray represents the motor applying current 73.

The motor applying current does not have a rapid increase, but a gradual increase by applying the integral signal, of which the rising time is increased by the RC integral circuit 33, to the motor 13 in A′ part in FIG. 7, compared with FIG. 2. The motor applying current does not have a rapid decrease, but a gradual decrease by applying the integral signal, of which the falling time is increased by the RC integral circuit 33, to the motor 13 in B′ part in FIG. 7, compared with FIG. 2.

According to the present invention comprised as above mentioned, the display rotating apparatus can prevent the slip phenomenon by rotary inertia.

Also, the display rotating apparatus can remove the slip phenomenon generated mechanically by increasing or decreasing slowly an applying voltage and/or current applied to the motor and reduce the sway by vibration at the time of stopping the display.

While the invention has been described with reference to the disclosed embodiments, it is to be appreciated that those skilled in the art can change or modify the embodiments without departing from the scope and spirit of the invention or its equivalents as stated below in the claims.

What is claimed is:

1. A display rotating apparatus comprising:
a motor providing a driving force for rotating a display; and
a motor driving device driving to rotate and stop gradually by increasing a rising time and a falling time of a rotation command signal.

2. The display rotating apparatus of claim 1, wherein the rotation command signal is a binary signal divided into rotation and stop.

3. The display rotating apparatus of claim 2, wherein the motor driving device comprises:
a rotation command signal applying unit generating the rotation command signal to rotate the motor corresponding to an input from outside;
an RC integral circuit generating an integral signal that is the rotation command signal of which the rising time and the falling time are increased; and
an H-bridge converting the integral signal to a motor applying signal to rotate the motor clockwise or counterclockwise.

4. The display rotating apparatus of claim 3, wherein the RC integral circuit generates the integral signal that is the rotation command signal of which rising time and falling time are changed by adjusting values of a resistor and a capacitor.

5. The display rotating apparatus of claim 3, wherein rotation speed of the motor is changed corresponding to magnitude of the motor input signal, and the magnitude of the motor applying current is changed gradually by the integral signal.
